(19) United States
(12) Patent Application Publication
(10) Pub. No.: US 2012/0318939 A1
(43) Pub. Date: Dec. 20, 2012

(54) TOOL TRAY AND DRAFTING TABLE FOR USE WITH CABLE-CONTAINING CARTONS

(75) Inventors: Richard GALGANO, Naperville, IL (US); Martin J. MCGUIRE, Downers Grove, IL (US)

(73) Assignee: WINDY CITY WIRE CABLE AND TECHNOLOGY PRODUCTS, LLC, Bolingbrook, IL (US)

(21) Appl. No.: 13/160,669

(22) Filed: Jun. 15, 2011

(51) Int. Cl. B65H 49/32; F16M 11/22; B65H 49/26; B62B 5/00; B65D 6/00

(52) U.S. Cl. 248/127; 280/79.3; 220/660; 242/598.3; 242/594.3

(57) ABSTRACT

A system for dispensing wire or cable from at least one carton has one or more reels disposed in the carton and a toolbox disposed to be above the carton. The tool box has a floor, left and right walls, and top and bottom fastening holes such that an axial rod may be inserted through the fastening holes, through the carton(s), and secured to a cart. The system preferably includes a drawing board that can be attached to the tool box.

### BACKGROUND OF THE INVENTION

Wire and cable for installation in residences and buildings typically comes on cable reels. The types of wire and cable include many different kinds of low-voltage, multiconductor insulated communications cable that are used for setting up Ethernet networks, intercom systems, entertainment systems and the connection of fire and security sensors and devices. A new building under construction will need many kinds of these cables, and several reels of cable will be used by an installer on-site.

One known technique is to provide coils of such cable in boxes, and to create a hole in a front or top panel of the (typically cardboard) box for pulling out a desired length of cable. This conventional method has a drawback in that the cable may kink inside of the box or otherwise resist being pulled out of the box to such an extent that a cable installer or technician finds that he or she is pulling the box across the floor. Often, the installer has to install several different lengths of cable on a single run. To do this, the installer has had to identify which kinds of cable he or she needs, individually pull cable out of separate boxes, and estimate the amount of cable so pulled. The assignee of the present invention has developed a reel-containing carton, described in U.S. Patent Application Publication No. 2008/0191436 A1, the specification and drawings of which are specifically incorporated by reference herein, which ameliorates some of these problems.

Additionally, these boxes of cable are heavy and it takes some effort to move them around, which fatigues the installer and leaves him or her susceptible to work-related injury. Further, since the exact wiring and cable specifications for any given project is likely to be customized based on the configuration of the building and the power and data requirements, the installer must frequently refer to the electrical and wiring prints in order to select the groups of wires and cables for each individual pull.

Therefore, the installer must not only install the wire and cable in a safe and efficient manner, but he is also responsible for and must transport a large number of reels, tools, and prints. As such, the modern electrician needs a comprehensive system that allows the installer to move the equipment and prints in an easy, efficient manner and facilitates quick access to them as well.

### SUMMARY OF THE INVENTION

According to one aspect of the invention, a system for dispensing wire or cable from reels includes one or more containers having a cable reel carton that includes a top panel, a bottom panel, and a left panel that extends from a left side of the top panel and a left side of the bottom panel so as to be orthogonal to the top and bottom panels. A right panel extends from the right side of the top panel and a right side of the bottom panel so as to be orthogonal to the top and bottom panels and spaced from the left panel. An axis is disposed approximately in the center of the left and right panels and an entry hole is disposed on the axis in each of the left and right panels.

A tool box is disposed to be above the at least one container and the tool box has a floor, a left wall with a left upward portion, and a right wall with a right upward portion. The left upward portion is affixed to and extends upwardly from the left side of the tool box floor and the right upward portion is affixed to and extends upwardly from the right side of the floor. At least one of the left or right walls has a downward portion that extends downwardly from the floor to be parallel to and adjacent to the corresponding left or right panel of the carton.

Each downward portion has a bottom fastening hole that is axially aligned with the axis and the left and right entry holes in the carton. An axial passageway is also disposed to be on the axis and includes the left entry hole, the right entry hole, the at least one container, and the bottom fastening hole.

In a preferred embodiment, the system includes a cart with a frame, left and right rod holders that are affixable to the frame, and a first axial rod that spans the length between the left and right rod holders. The first axial rod may be inserted through the axial passageway and through holes in the left and right rod holders. A second axial rod may be inserted through a top fastening hole in each of the upward portions of the left and right walls and affixed to the left and right rod holders.

More preferably, the system includes a drawing board with a substantially planar surface, a first tab, and a second tab. Each tab is formed to extend orthogonally from the planar surface such that the tabs may be placed between either the front wall or the rear wall of the tool box and the axial rod passing through the top fastening holes so that the axial rod and the front or rear wall supports the drawing board.

### BRIEF DESCRIPTION OF THE DRAWINGS

Further aspects of the invention and their advantages can be discerned in the following detailed description, in which like characters denote like parts and in which:

FIG. 1 is an isometric view of a single container or carton according to the invention, in which an outer carton wall is shown in phantom to reveal internal components;

FIG. 2 is an exploded view of a cable reel and support caddies used in the container shown in FIG. 1;

FIG. 3 is an isometric view of a mobile cable dispensing system according to the invention, as including a cart;

FIG. 4 is a detail of the right end of the cart shown in FIG. 3;

FIG. 5 is a detail of the left end of the cart shown in FIG. 3;

FIG. 5A is a detail sectional view taken substantially along line 5A-5A of FIG. 5;

FIG. 6 is an isometric view of the cart shown in FIG. 3, in a folded or “broken down” condition in which it can be easily transported or stored;

FIG. 7 is an isometric view of two stacked cartons according to an further embodiment of the invention, showing pass-through slots and the function of vertical cable pass-through;

FIG. 8 is an isometric view of a tool box for use as part of the mobile cable dispensing system;

FIG. 9 is an isometric view showing a cart having stacked cartons and the tool box of FIG. 8;

FIG. 10 is an isometric view of a drawing board to be used with the tool box of FIG. 8; and

FIG. 11 is an isometric view of the drawing board of FIG. 10 being used with the tool box of FIG. 8.

### DETAILED DESCRIPTION

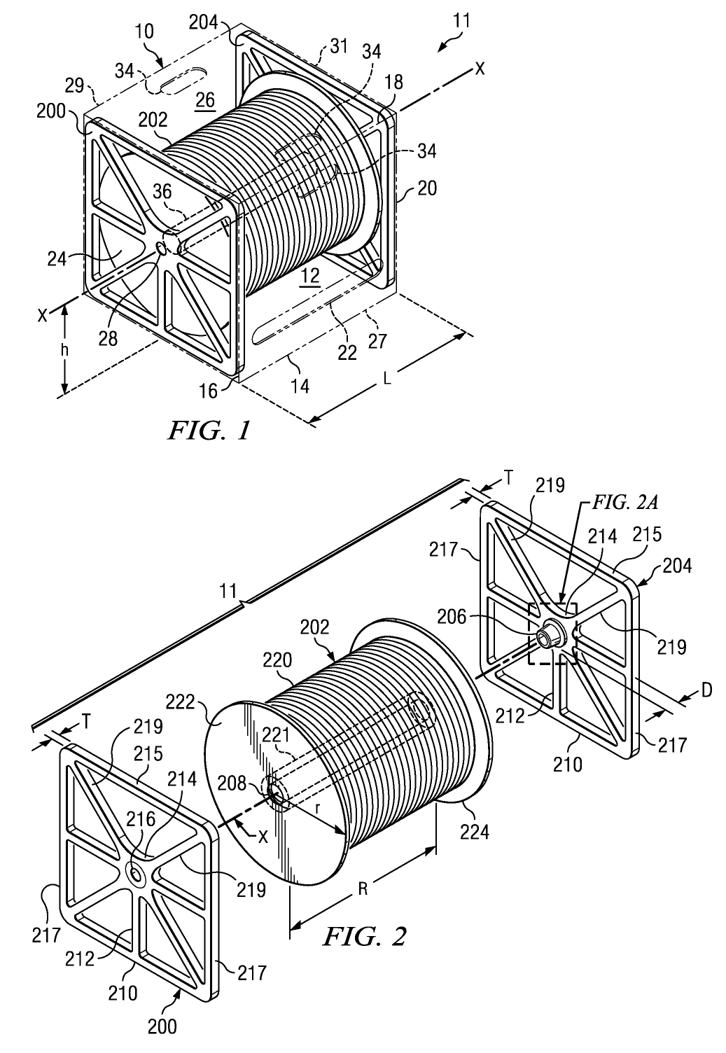

FIGS. 1 and 2 show a cable reel carton indicated generally at 10, which in turn forms the exterior components of a cable reel container 11. Carton 10 is preferably formed of a single sheet of corrugated cardboard and includes a front panel 12 having a bottom side 14, a left side 16, a top side 18 and a right side 20. The front panel 12 preferably has, in a lower portion thereof, an elongate die-cut cable dispensing or payout slot 22 through which cable or wire may be pulled. The slot 22 is elongate in a direction parallel to a cable reel axis X and is long enough to permit cable to come off the reel at right angles to the reel axis and through the slot 22, no matter where on the reel the cable is presently being unspooled. Preferably, the length of the slot 22 is selected to be at least roughly the same as the distance between the internal surfaces of the two cable reel flanges (described below).

The carton 10 also includes a left panel 24 which extends rearward from side 16 and at right angles to the front panel 12, and a top panel 26 which extends rearward from top side 18 and at right angles to the front panel 12 and left panel 24. The carton 10 is completed by a bottom panel 27, a rear panel 29 and a right panel 31, the last of which is a mirror image of the left panel 24. An entry hole 28 is formed in left panel 24 around the horizontal axis X, axis X being a predetermined distance h from an upper surface of the carton bottom panel 27.

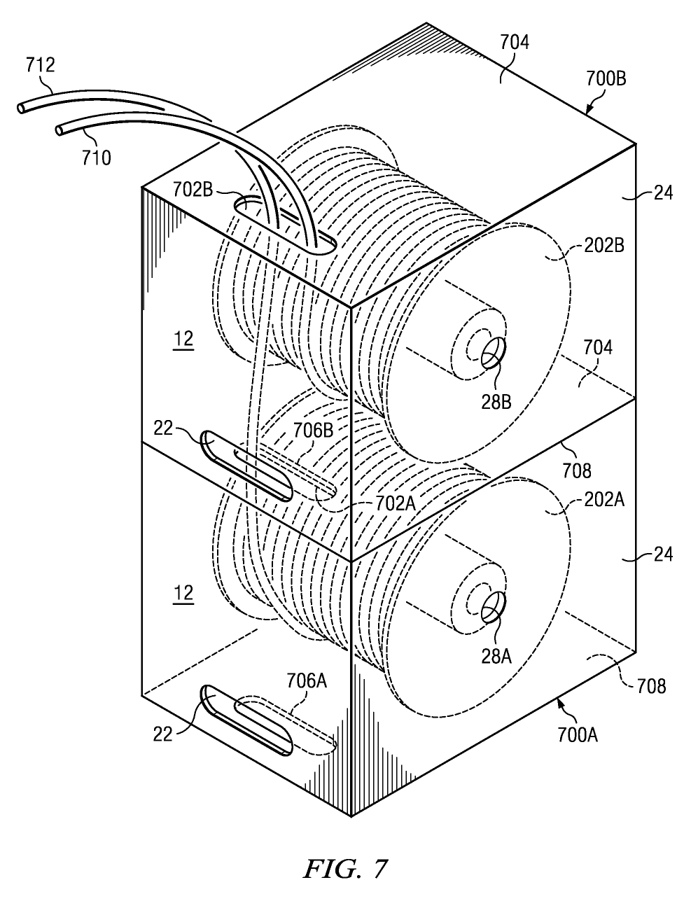

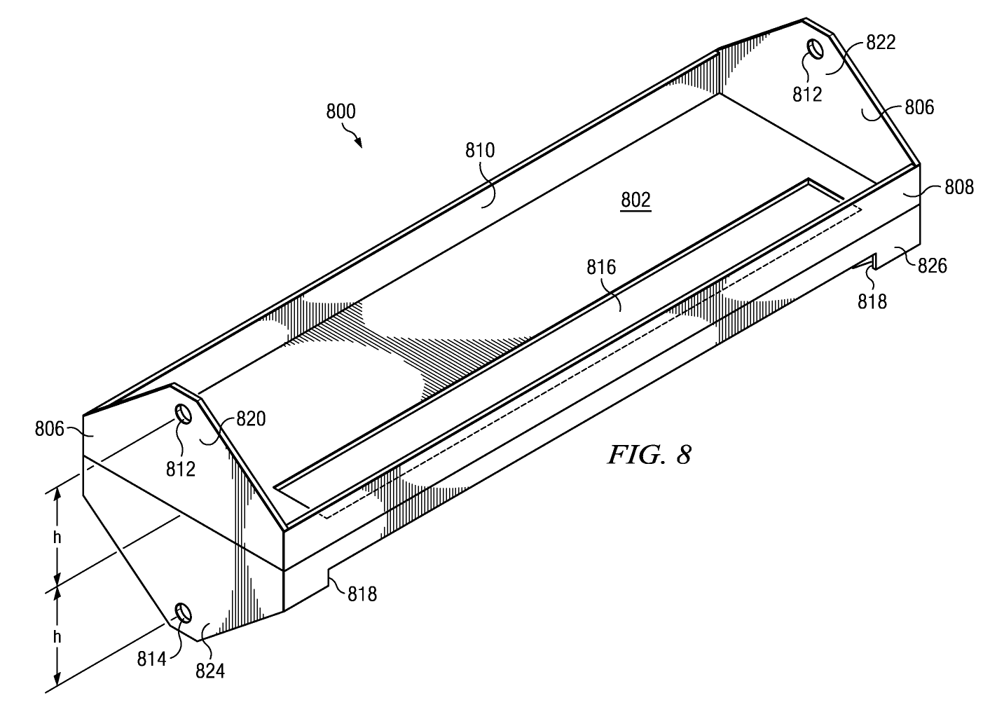

Conveniently, one or more handholes 34 may be die-cut into the cardboard panels 12, 26, 29 for ease in handling. In one embodiment, the cable payout slot 22 can be repeated in top panel 26 and/or rear panel 29, so as to give the user some flexibility in arranging the cartons in the mobile unit or on the cart (later described) and some ability to select how the cable will exit the carton 10. An embodiment in which the carton has elongate pass-through slots in both the top and bottom panels is described in conjunction with FIG. 7.

The interior components of the container 11 are shown in exploded view in FIG. 2. A preferably spoked left caddy 200 is, in use, disposed interiorly adjacent an inner surface of the left carton panel 24. The caddy 200 may be injection-molded from a tough plastic that is capable of suspending half of the weight of a full cable reel 202 without buckling. A right caddy 204 can be formed from the same mold as the one which makes left caddy 200. In use, the right caddy or reel support member 204 is positioned interiorly adjacent to an inner surface of the right carton panel 31.

Each caddy 200, 204 has a substantially cylindrical bushing 206 which extends axially from a general plane in which the remainder of caddy 200, 204 is formed toward the other caddy. The bushing 206 could be formed from a surface of rotation other than a straight cylinder; it could, for example, have a terminal lip of increased radius that would run in an annular groove (not shown) in the reel flange central hole 208. Such a departure from a straight cylinder could allow the caddies 200, 204 to be snapped to the cable reel 202. In the illustrated embodiment, the bushing surface 206 is slightly tapered toward its free end and has a terminal curved or rounded surface. For the purpose of defining the surface of bushing 206 as “substantially cylindrical,” these departures from a perfect mathematical cylinder are to be included in the definition. The taper and terminal curved or rounded surface aid in registering the bushing 206 within the reel flange central holes 208.

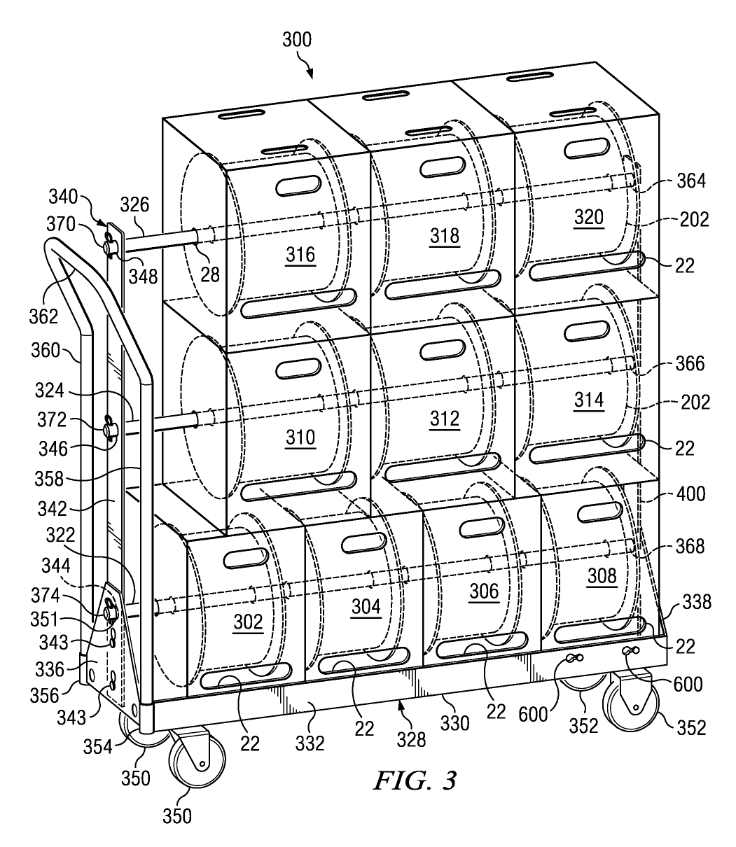

The caddies or cable reel support members 200, 204 have bodies which generally conform in two dimensions to the interior of the carton 10 into which they are designed to be placed, and in general will be of slightly smaller dimension than, but will conform to the shape of, the left box panel 24 and the right box panel 31. The caddies 200, 204 suspend between them a reel 202 of cable that can weigh many dozens of pounds. Accordingly, it is preferred that each caddy 200, 204 have a horizontal base member 210 which is meant to rest on an upper surface of bottom carton panel 27. A central, vertically oriented spoke 212 can be formed to extend from the base member 210 to a central portion 214, from which in turn bushing 206 extends. The spokes 212 will bear most of the weight of the reel 202. Preferably, each caddy has a top rail or horizontal member 215 which in use is disposed adjacent an internal surface of top panel 26 of the carton 10. The top rail 215 can in turn be supported by side rails 217 and angled spokes 219. The top rail 215 is useful in accepting a columnar load imposed by other reel containers 11 placed on top of the particular reel container 11 of which the caddies 200, 204 are a part. Such container stacking occurs in the use of the cart illustrated in FIGS. 3, 4, and 9 as described below.

Preferably, the panels of carton 10, the caddies 200, 204, the cable reel 202 and the bushings 206 are so sized that the carton interior prevents the reel 202 from coming off of the bushings 206. The carton 10 will have an internal length L in between the internal surfaces of side panels 24 and 31. Most of the distance L will be occupied by the reel 202, which has a predetermined length R between external surfaces of the reel flanges 222, 224. Each caddy 200, 204 will have a general body thickness T. The bushings 206 extend inwardly from the general interior surfaces of the caddies 200, 204 by a distance D. Preferably, the dimensions of these components are selected such that 2T+R is slightly less than L. On the other hand, 2T+R+2D should be somewhat greater than L, such that the cable reel 202 is forced to ride on the bushings 206 while the caddies 200, 204 and the reel 202 are inside of the carton 10. This dimensioning would not be necessary in those embodiments in which the caddies are snapped or otherwise affixed to the reel 202 prior to the insertion of all three components into a carton or box 10. Further, there will be variations in reel lengths according to the amount and kind of cable wound thereon. In many cases, the caddies 200, 204 will be used in many different carton sizes, so that dimension L of the carton 10 should closely follow cable reel length R.

The cable reel 202 is preselected to have a flange radius r which is smaller than axis height h. This will ensure that the reel 202 can rotate freely inside of carton 10 on bushings 206.

Each caddy 200, 204 has a caddy hole 216 sized to receive an axial rod (later described) therethrough. Each reel 202 has a reel passageway 221 that joins together reel flange central holes 208. Conveniently this reel passageway 221 can be formed by an interior volume of a tube which also bears the wound cable 220 on its exterior surface. As assembled and in the condition shown in FIG. 1, each carton 10 therefore has a free passageway 36 all the way along axis X from one side of the box 10 to the other, including a left entry hole 28, caddy hole 216 in caddy 200, central hole 208 in left cable reel flange 222, a reel passageway 221 between left cable reel flange 222 and right cable reel flange 224, a caddy hole 216 in right caddy 204, and an entry hole 28 in the right carton panel 31.

As described in U.S. application Ser. Nos. 12/486,063, 12/545,517, and 12/103,790, the specifications and drawings of which are expressly incorporated by reference, the carton may also contain multiple reels within the same carton along the same axis, or may have multiple reels within the same carton on different, parallel axes.

In many instances a user or installer will wish to pull the same length of different kinds of cable at the same time, usually to be installed along the same run. FIG. 3 illustrates a cart or vehicle 500 which makes this very convenient to do.

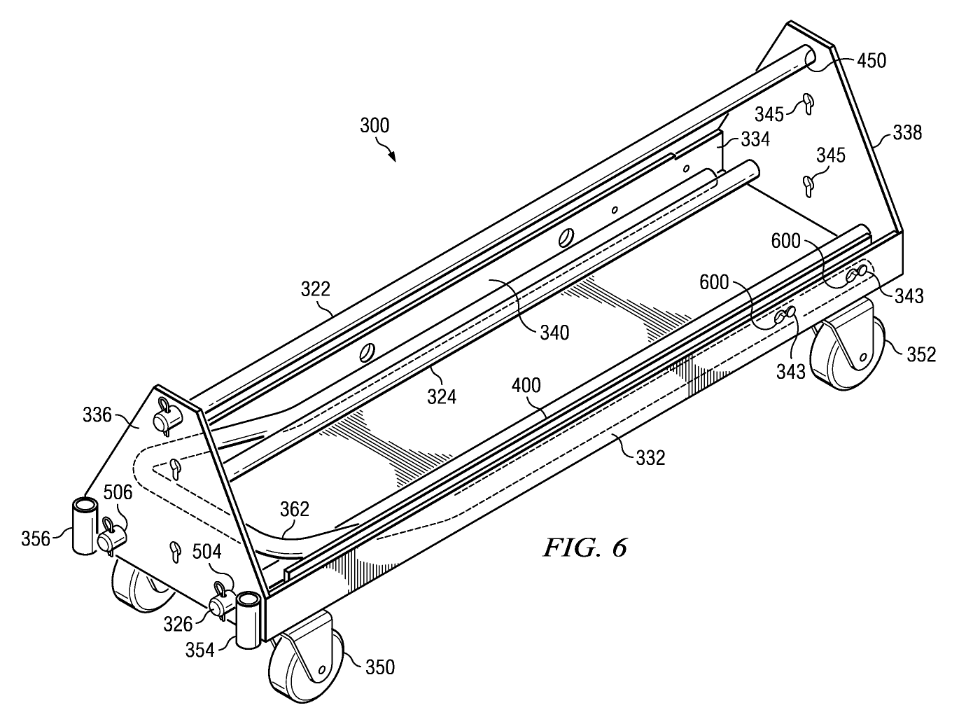

FIGS. 3-6 show a four-wheeled cart 300 to which containers 302-320 can be mounted in up to three parallel rows, one each for respective axial rods 322, 324 and 326. The axial rods 322-326 are preferably parallel to but vertically spaced apart from each other so as to each be coaxial with a respective row of containers through which they are inserted. FIG. 3 shows the cart 300 in a use configuration. When not in use, it may be collapsed to a storage configuration, as explained in conjunction with FIG. 6.

The cart 300 is built on an elongate rectangular frame 328 which has a bottom plate 330, front and rear panels or plates 332 and 334 which extend upwardly from the longitudinal edges of bottom panel 330 and which are preferably orthogonal to panel 330, and left and right panels 336 and 338 which extend upwardly from the transverse edges of bottom panel 330 and preferably are orthogonal to plates 330-334 and parallel to each other. Panels 330-338 can be formed from a single blank of sheet steel and together form a shallow box sized to receive the first row of reel containers 302-308. The height of front panel 332 is chosen to be somewhat less than the height of cable payout slots 22 above the bottom panels of the containers 302-308, such that the cables being withdrawn from slots 22 will not be occluded or abraded by the side panel 332. The height of the rear panel 334 can be preselected to be taller than this, or can be the same height, in case that the installer chooses to face the slots 22 (or even just some of them) the opposite way.

A vertical, elongate, preferably flat left axial rod holder 340 can have its lower end 342 affixed as by riveting or welding to left panel 336. The left axial rod holder 340 more preferably is affixed to the left panel 336 by flat-headed studs 343 formed to extend from a surface of holder 340 and keyed slots 345 formed in panel 336 which have top openings sized and shaped to receive therethrough a head of a respective stud 343, and a slot depending from this opening which accepts only a shaft of the stud 343. Other user-operable fasteners such as pins or nuts and bolts could alternatively be employed. As assembled to cart 300, the left axial rod holder 340 extends upwardly from the left panel 336 at least beyond the horizontal level of the third and highest axial rod 326. Holes 348, 346, 344 are made in left axial rod holder 340 to be sized and positioned to slidably receive second ends 370, 372, 374 of respective ones of the axial support rods 326, 324, 322. The axial rods 322-326 are preferably straight and have through-holes drilled through their sidewalls near at least their second ends 370, 372, 374, so as to receive clevis pins after insertion of the rods through respective holder holes 344-348.

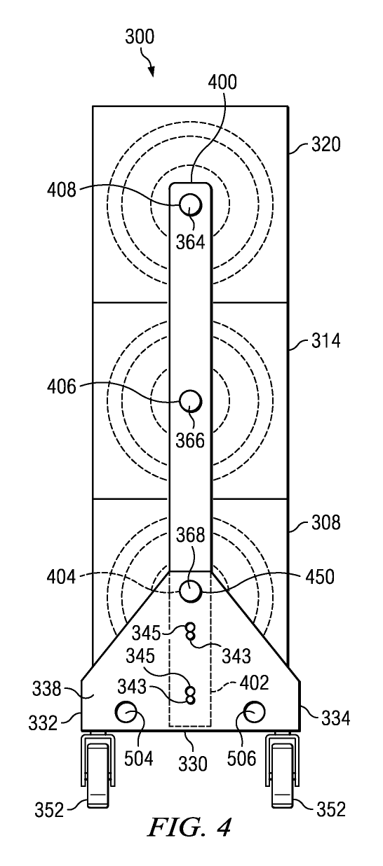

Similarly, in a use configuration a vertical elongate right axial rod holder 400 (FIG. 4) has a lower end 402 affixed to right plate 338 as by riveting, welding or (preferably) user-operable fasteners such as studs 343 received into respective keyed slots 345. The right axial rod holder 400 extends upwardly from the right panel 338 at least beyond the horizontal level of the third axial rod 326. Holes 404, 406, and 408 are made in a right axial rod holder 400 and are sized and positioned to slidably receive first ends 364, 366, 368 of the respective ones of the axial support rods 326, 324 and 322. Clevis pins may be inserted through diametrically opposed holes drilled in the sidewalls of the first and second ends 364, 366, 368, 370, 372, 374 in order to fasten the rods in place. Alternatively, caps (not shown) may be threaded onto the ends of the axial rods 322-326 so as to secure the reel containers 302-320 between rod holders 340 and 400.

Still referring to FIGS. 3 and 4, the left panel 336 and the right panel 338 preferably extend upwardly beyond the level of the lowest axial support rod 322. Holes 351, 450 are made in the left and right panels 336, 338 to slidably receive therethrough the axial support rod 322. Extending the left and right panels 336, 338 upwardly in this manner obviates any transverse deflection of the axial rod holders 340, 400 at this height, and enhances the resistance to such deflection at locations higher up on the axial rod holders 340, 300. The upward extension of left and right panels 336, 338 also permits the formation of holes 351, 450 therein to receive the lowest axial rod 322 therethrough while the cart 300 is in a storage configuration, as will be hereinafter described.

The bottom panel 330 of the cart 300 has affixed thereto, as by riveting or welding, two front casters 350 which turn on their vertical axes and two rear casters 352 which don't. In one embodiment some or all of the casters 350-352 may be of the type which are equipped with foot-actuated brakes (not shown), so that the cart 300 may be parked in one place.

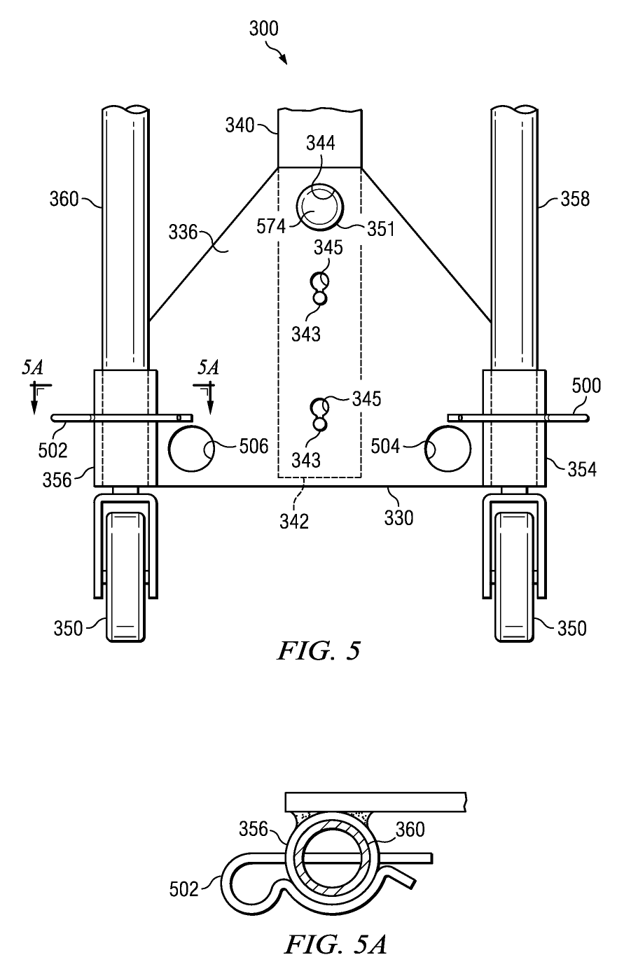

Referring to FIGS. 3 and 5, at the left corner of the front 332 and left 336 panels, there is provided a socket 354, which may be joined to front panel 332 and left panel 336 by welding. Similarly, at the left corner of rear panel 334 and left panel 336 there is provided a socket 356. Sockets 354 and 356 are vertical cylindrical sleeves meant to slidably receive respective front and rear legs 358, 360 of a handle 362.

As shown in the detail of FIG. 5A, the front and rear legs 358, 360 of the handle 362 can be affixed to respective sockets 354, 356 by means of cotter or clevis pins 500, 502. A shaft of each clevis pin 500, 502 is inserted into a hole in a respective socket 354 or 356, a hole in a respective handle leg 358, 360, a hole in the opposite wall of handle leg 358 or 360 (which conveniently can be formed of tubular steel), and finally through an inboard hole in a respective socket 354 or 356. Another, curved leg of each clevis pin 500, 502 meanwhile fits around the curved external surface of socket 354 or 356, thereby locking the pin 500 or 502 in place.

FIG. 5 also provides a close-up view of storage holes 504, 506 which are not used when the cart 300 is loaded with cartons, but which are used to receive ends of axial rods 324, 326 when the cart 300 is being separately transported or stored.

FIG. 6 shows the cart 300 in a “knocked down” condition. The axial rod holders 340, 400 are stored on the sides of the cart interior. Keyed storage slots 600 are formed in sides 332, 334 so as to receive studs 343 of the axial rod holders 340, 400, affixing them in place in a storage configuration. Axial rods 326, 328 are threaded through storage holes 504, 506, and like storage holes in the right panel 338, and affixed in place as by means of cotter or clevis pins, so they don't slide out. The legs 358, 360 of cart handle 362 are removed from respective sockets 354, 356 and laid into the interior of the cart 300. The lowest axial rod 322 is reattached in the same position that it takes when cartons are mounted to it, but is now used as a handle to carry the cart 300.

Returning to FIGS. 3 and 4, cart 300 permits the stacking of containers 302-320 three rows high, and in alternative embodiments (not shown) a fourth or even more rows could be added, as long as the entire cart 300 is not in danger of tipping over. The containers 302-320 have a lessened danger of tipping over when cable is pulled from them than they otherwise would, as during a cable pull the cable is being pulled off of rotating spools 202 internal to the cartons 302-320. The rotation of spools in the cartons 302-320 around their respective axes relieves most of the tension caused by pulling the cables, and as such the shear force experienced by the whole structure will be less than it otherwise would be. The combination of the cart 300 and the containers 302-320 create a wall or two-dimensional array of reels from which cable may be pulled.

In use, the installer installs one, two, or three rows of containers 302-320 on cart 300, employing one, two or three axial support rods 322-326. If only one row of containers 302-308 is to be used, the axial rod holders 340 and 400 aren't necessary and don't have to be installed. Otherwise the axial rod holders 340 and 400 are bolted on or otherwise fastened to the left and right plates 336 and 338, preferably in advance of loading a first row of reel containers 302-308 onto the bottom plate 330. The lowest axial rod 322 is then threaded through plate 336, axial rod holder 340, containers 302-308, right plate 338 and right axial rod holder 400, and is fastened in place by means of threaded end caps (not shown) or clevis pins. Then, a second row of containers 310-314 is installed in a similar manner, using second axial rod 324. If needed, a third row of containers 316-320 is installed using third axial rod 326. Legs 358, 360 of the handle 362 are then installed in respective sleeves 354 and 356.

The cart 300 is then rolled to a desired location and is parked (as by setting its caster brakes) such that its long axis (and therefore the axes of the axial rods) is at a substantial angle (such as a right angle) to the direction of cable pull. The combined mass of cart 300 and its payload provides a massive anchor against which cable can be pulled out of containers 302-320 through slots 22.

FIG. 7 depicts an embodiment permitting the dispensing of cable from each reel in a vertical stack of containers 700A, 700B. Each container 700A, B is like container 11 (FIG. 1) in most respects and each such container 700A, 700B houses a reel 202A, 202B of cable as supported by reel caddies or mounting plates (omitted from FIG. 7 for clarity). Each container 700A, B has an entry hole 28A or 28B in each of its side panels and a free passageway 36 between them, as before. Each container 700A, B further has a front panel cable dispensing slot 22.

The containers 700A, B are different from containers 11 in that each additionally has an elongate top pass-through slot 702A or 702B in a top panel 704 thereof, and an elongate bottom pass-through slot 706A, 706B in a bottom panel 708 thereof. The top pass-through slot 702A, 702B should be positioned in top panel 704 in a way which is similar to the positioning of bottom pass-through slot 706A, 706B in bottom panel 708. This is so a top pass-through slot 702A in one container 700A will communicate with a bottom pass-through slot 706B in the container 700B immediately on top of it. As in front slots 22, it is preferred that top and bottom slots 702A,B, 706A, B be offset from the middle of the panel and to be parallel to, but offset, from the vertical plane which the reel axes will tend to occupy. Said another way, a plane containing the centers of all pass-through slots 702-706 in the stack will be parallel to but spaced from the plane containing the reel axes in the stack.

The pass-through slots 702A, B, 706A, B permit cables from different reels to exit out the top one of the slots 702B in common. By way of example, in FIG. 7 a first cable 710 originates from a lower cable reel 202A. The cable 710 is fed through a pass-through slot 702A prior to the upper container 700B being placed all the way onto the lower container 700A. The cable 710 is fed through the bottom pass-through slot 706B in the upper container 700B, and thence out the top pass-through slot 702B. A cable 712 originates from an upper reel 202B, and is simply threaded out of the top slot 702B. The wide extent of the slots 702A, B, 706A, B allows multiple cables 710, 712 (only two such shown here) to be pulled out of the top of the stack with little resistance and with little interference with each other.

FIG. 8 shows a toolbox for use with the system. The tool box, indicated generally at 800, is disposed to be above and supported by the cable reel cartons 302-314 of the containers and has a floor 802, a left wall 804 with a left upward portion 820, a right wall 806 with a right upward portion 822, a front wall 808, and a rear wall 810.

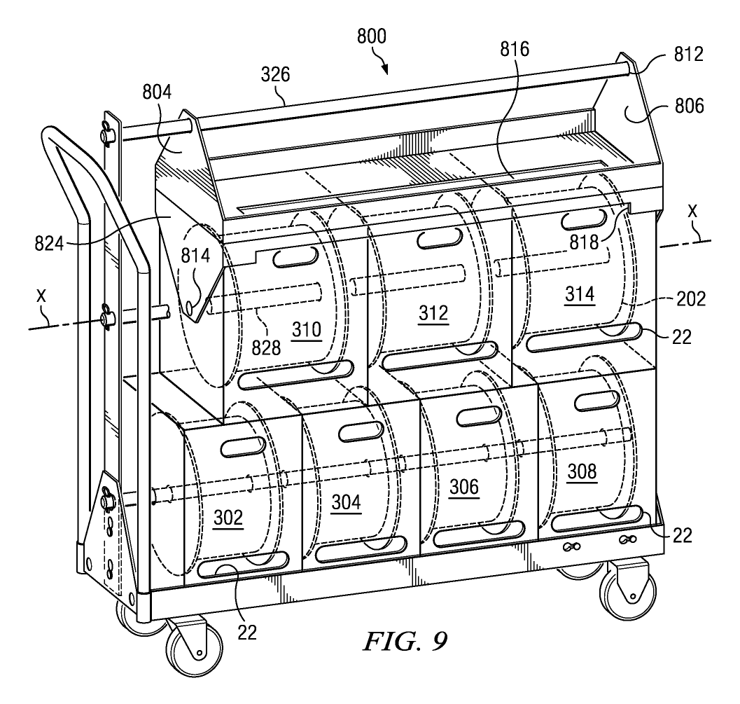

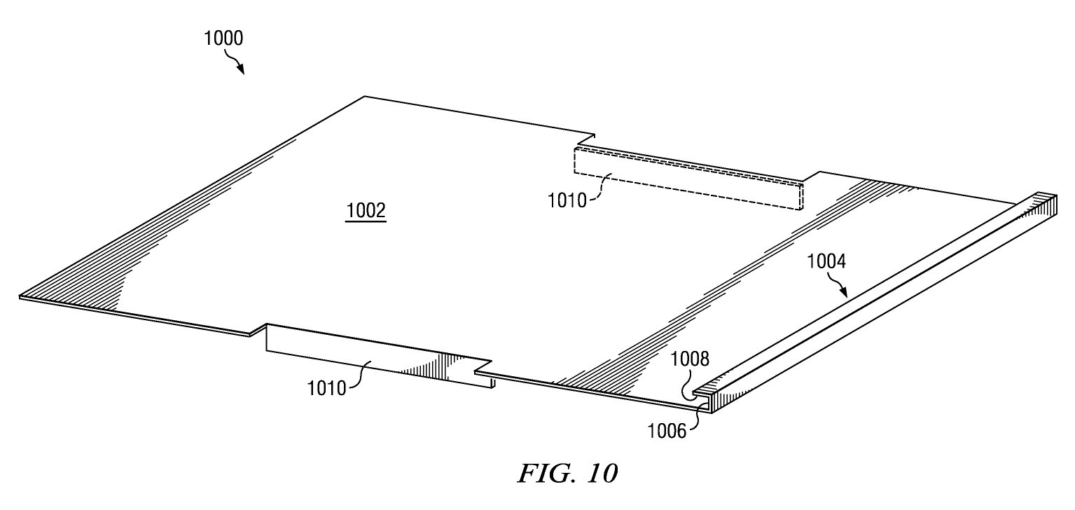

FIG. 9 shows the floor 802 of the tool box 800 resting on top of the carton or cartons 310-314 and spanning a width of the top panels 26. The left and right walls 804, 806 extend upwardly from respective left and right sides of the floor 802 and may be affixed to the floor 802 by known techniques such as welding. Alternatively, the walls 804, 806 may be integrated into the floor. Since each of the containers 302-314 has a standard height (2h), the top panels of containers 310-314 are coplanar and provide a secure base upon which tool box floor 802 can rest.

One or both of the left and right walls 804, 806 has a downward portion 824 that extends downwardly from the floor 802 to be parallel to and adjacent to the corresponding left or right panel or panels 24, 31 of the carton 10. Downward portion 824 extends downwardly by a distance of more than h, so that axis X, passing though the centers of each of the top row of containers 310-314, will also pass through it. Further, the front wall 808, the rear wall 810, or both may extend below the floor 802 of the tool box 800 to be adjacent to the outer surfaces of the front or rear panels 12, 29 of the cartons 310-314. In this way, the walls 804, 806, 808, 810 of the tool box 802 may help secure the tool box 800 on top of the carton or cartons 310-314. Further, a cutout 818 may be formed into a lower portion 826 of the front and/or rear walls 808, 810 so printed indicia on the carton or cartons 302-314 is visible to the installer. Preferably, a length of the tool box 800 is preselected to be longer than the combined length, in an axial direction, of at least two of the containers 310-314.

Preferably, each of the upward portions 820, 822 of the left and right walls 804, 806 is more than the distance h high and has a top fastening hole 812 so that a second axial rod 324 may be passed through the top fastening holes 812, a hole 408, 406 in the right rod holder 400, and a hole 348, 346 in the left rod holder 340 to secure the tool box 800 and the container 11 to the left and right rod holders 340, 400. Bottom fastening holes 814 may be formed in the lower portion 824 of the one or more walls 804, 806 that extend below the floor 802 so that the wall or walls 804, 806 is adjacent to an outside surface of the left or right carton panels 16, 20. Preferably, the bottom fastening hole 814 is aligned with the axis X and the left and right entry holes 28A, 28B. More preferably, the distance between the top fastening hole 812 and the bottom fastening hole 814 approximates a standard height 2h of the container or containers.

Thus, an axial passageway 828 is formed through the left and right entry holes 28A, 28B, the carton or cartons 11, and the bottom fastening hole or holes 814. The first, lowest axial rod 322 is passable through the axial passageway 828 and has a preselected length that is longer than the length of the axial passageway. As described above, the axial rod is affixable to the right and left rod holders 340, 400.

As above, the second ends 370, 372, 374 of the axial rods 322, 324, 326 are enlarged in some manner to prevent the first ends 364, 366, 368 from passing through the holes 404, 406, and 408 in the right axial rod holder 400. In this way, the tool box 800 can be secured to the cart 300 by the first axial rod 324, the second axial rod 326, or both.

Also, just as the cartons 10 have pass-through slots 702A, B (see FIG. 7), the tool box 800 also preferably has a pass-through slot 816 that is formed in the floor 802 to be parallel to the axis X of the reel 202. The centers of the carton pass-through slots 702A, B, 706A, B, and the tool box pass-through slot 816 should be formed in a plane which is offset from the axis, X. Thus, when the tool box 800 is stacked on top of one or more cartons (see FIG. 9), a position of each of the slots 702 A, B, 706A, B, 816 should be in registration with the position of the other slots so that cable 710, 712 from the reels 202 A, B can be passed through the carton pass-through slots 702 A, B and the tool box pass-through slot 716.

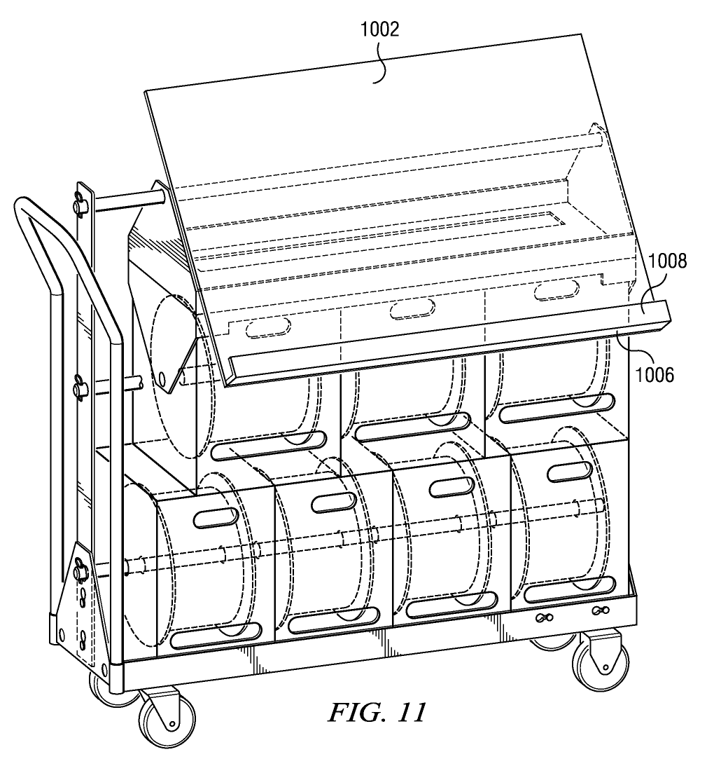

Referring to FIGS. 10 and 11, the system preferably includes a drawing board, indicated generally at 1000, that has a substantially planar surface 1002 on which a print or drawing can be positioned or affixed. The drawing board also has first and second tabs 1010 that are formed to extend orthogonally from the planar surface 1002 so that they may be placed between either the front wall 808 or the rear wall 810 of the tool box 800 and the axial rod passing through the top fastening holes 812 thereof. As such, the rod and the wall 808 or 810 supports the drawing board 1000 and presents the print positioned thereon at an angle convenient for viewing.

Preferably, the drawing board 1000 also has a flange, indicated generally at 1004, having a first side 1006 extending from the planar surface 1002 in a direction that is opposite the tabs 1010 as well as a second side 1008 adjoining the first side 1006 to form a channel. This channel can then prevent any drawing from sliding off.

In the event that the system is used outdoors, the drawing board 1000 may also include means for retaining the drawing or print onto the board 1000. Conventional retaining means such as clips, rubber or elastic bands, or protective sheets may be used to secure the print or drawing to the board 1000.

In summary, a cable container has been provided in which a reel of cable rotates freely on caddies inside of a carton as cable is being drawn out of an offset elongate slot. With the aid of an axial support rod inserted through multiple ones of these containers, two or more such containers and a toolbox can be secured to a single mobile cable pulling unit.

While illustrated embodiments of the present invention have been described and illustrated in the appended drawings, the present invention is not limited thereto but only by the scope and spirit of the appended claims.

We claim:

1. A system for dispensing wire or cable from reels, comprising:
at least one container having a cable reel carton including
a top panel, a bottom panel, a left panel extending from a left side of the top panel and a left side of the bottom panel so as to be orthogonal to the top and bottom panels, a right panel extending from the right side of the top panel and a right side of the bottom panel so as to be orthogonal to the top and bottom panels and spaced from the left panel, an axis disposed approximately in the center of the left and right panels, and an entry hole disposed on the axis in each of the left and right panels; and
a tool box disposed to be above the at least one container, the tool box comprising
a floor having a left side and a right side;
a left wall having a left upward portion affixed to and extending upward from the left side of the floor;
a right wall having a right upward portion affixed to and extending upward from the right side of the floor;
at least one of the left and right walls having a downward portion extending downwardly from the floor to be parallel to and adjacent to the corresponding left or right panel of the carton, a bottom fastening hole in each downward portion being axially aligned with the axis and the left and right entry holes in the carton; and
an axial passageway disposed on the axis through the left entry hole, the right entry hole, the at least one container, and the bottom fastening hole.

2. The system of claim 1, further comprising a cart having an elongate frame, a left panel of the frame disposed in a vertical plane, a right panel of the frame disposed in a vertical plane displaced from the left panel;
a plurality of wheels affixed to the elongate frame;
a left rod holder affixable to the left panel of the frame to extend upwardly therefrom;
a right rod holder affixable to the right panel of the frame to extend upwardly therefrom; and
a first axial rod spanning the distance between the right rod holder and the left rod holder, a first end of the first axial rod being received into a hole in the left rod holder, a second end of the first axial rod being received into a hole in the right rod holder, and the first axial rod extending along the axis through the axial passageway and being affixable to at least one of the right rod holder and the left rod holder.

3. The system of claim 2, further comprising a top fastening hole in the left upward portion of the left wall, a top fastening hole in the right upward portion of the right wall, and a second axial rod that is passable through the top fastening holes, the hole in the right rod holder, and the hole in the left rod holder.

4. The system of claim 2, the at least one container further comprising at least first and second ones of the containers positioned side by side such that the axial passageway includes the first and second containers and the bottom fastening hole;
wherein the floor of the tool box is disposed to be on the first and second cartons and spans a width of the top panels of the first and second cartons and an axial rod is inserted through the axial passageway, the axial rod having a preselected length that is longer than the length of the axial passageway.

5. The system of claim 3, wherein the second axial rod secures the tool box to at least one of the right and left rod holders.

6. The system of claim 3, wherein the second ends of the first and second elongated axial rods are enlarged so as to affix the at least one container and tool box to the cart.

7. The system of claim 3, wherein a vertical distance between the top fastening holes and the bottom fastening hole approximates a height, 2h, of the at least one container, such that the downward portion is greater than h, the upward portion is greater than h, and h is the distance between the bottom panel and the cable reel axis.

8. The system of claim 1, further comprising:
a first pass-through slot formed in the top panel of the at least one container so as to be parallel to the axis; and
a tool box pass-through slot formed in the floor of the tool box to be parallel to the axis;
wherein centers of the first pass-through slot and the tool box pass-through slot are formed in a plane which is offset from the axis, a position of the first pass-through slot matching a position of the tool box pass-through slot.

9. The system of claim 8, further comprising
a second pass-through slot formed in the bottom panel of the at least one container;
wherein centers of the first pass-through slot, the second pass-through slot, and the tool box pass-through slot are formed in a plane which is offset from the axis, a position of the second pass-through slot matching the position of the first pass-through slot and the tool box pass-through slot, such that when the tool box is stacked on top of a first container, which is resting on second container, cable from the first and second containers may be passed through the first container and out the tool box pass-through slot.

10. The system of claim 1, the tool box further comprising:
a front wall affixed to a front side of the floor; and
a rear wall affixed to a rear side of the floor;
wherein a lower portion of at least one of the front wall and rear walls extends downwardly below the floor.

11. The system of claim 11, further comprising a cutout in the lower portion such that printed indicia on the carton is visible.

12. The system of claim 3, further comprising a drawing board having a substantially planar surface on which a print or drawing may be positioned, a first tab, and a second tab, each tab formed to extend orthogonally from the planar surface, such that the first and second tabs may be placed between either the front wall or the rear wall and the axial rod passing though the top fastening holes, the second axial rod and the front or rear wall supporting the drawing board.

13. The system of claim 12, further comprising a flange having a first side orthogonal to and extending from the planar surface in a direction opposite the first and second tabs and a second side orthogonal to the first side such that the first side, the second side, and the planar surface form a channel.

14. A tool box tool box comprising
a floor having a left side and a right side;
a left wall having a left upward portion affixed to and extending upward from the left side of the floor;
a right wall having a right upward portion affixed to and extending upward from the right side of the floor;
at least one of the left and right walls having a downward portion extending downwardly from the floor, a bottom fastening hole in each downward portion being axially aligned on an axis.

15. The tool box of claim 14, further comprising a top fastening hole in the left upward portion of the left wall and a top fastening hole in the right upward portion of the right wall.
